(19) United States
(12) Patent Application Publication
(10) Pub. No.: US 2012/0162115 A1
(43) Pub. Date: Jun. 28, 2012

(54) PORTABLE MULTIMEDIA DEVICE WHICH DISPLAYS DOCUMENT HAVING MULTIPLE PAGES

(76) Inventor: Byung Keun Lim, Gunpo Si (KR)

(21) Appl. No.: 13/394,149

(22) PCT Filed: Aug. 30, 2010
(86) PCT No.: PCT/KR2010/005827

§ 371 Date: Mar. 4, 2012

(30) Foreign Application Priority Data
Sep. 4, 2009 (KR) 10-2009-0083518

(51) Int. Cl. G06F 3/041; G06F 17/00

(52) U.S. Cl. 345/173; 715/273

(57) ABSTRACT

A portable multimedia device for displaying a document having multiple pages. The portable multimedia device comprises a memory for storing the document; at least one display screen for displaying the document; and a central control unit for reading the document from the memory and displaying the document on the at least one display screen according to an operating mode selected by a user, wherein the central control unit comprises a page indicator display module for displaying page indicators, indicating current, previous, and next pages of the document, to be selected by the user, and a target page select module for displaying on the at least one display screen a target page that corresponds to one of the page indicators [finally] selected by the user. Accordingly, with the portable multimedia device, the user may easily spot a desired page of the document and may turn over pages to the desired page.

### TECHNICAL FIELD

The present invention relates to portable multimedia devices and, more particularly, to a display unit, especially, in an e-Book device, an e-Note device, etc., and associated application software.

### BACKGROUND ART

With the development of electronics and materials technology, lightweight and compact portable multimedia devices, which are capable of storing and reproducing electronic multimedia information, such as, e-Book, e-Dictionary, net-book, etc., have been widely spreading, An e-Book device allows a user to conveniently purchase and download novels, poems, textbooks, reference books, etc. online, which are digitally documented. Further, it also allows a user to take a note on the display screen by adding a pen input function.

In addition, for user convenience, a portable multimedia device having two or more display screens for displaying vast amounts of information at once has been widely developed. When using the two or more display screens of the portable multimedia device, the portable multimedia device can simultaneously perform different tasks on different display screens, thereby contributing to an increase in usability of the display device.

However, even though the two or more display screens are provided, it is impossible to display thereon all pages of a document. In other words, only a portion of a multi-page document can be displayed at a time. Accordingly, it is desirable if the user can easily move among multiple pages to a target page other than a currently displayed page.

In this regard, in conventional arts, one can only manually input a target page number in a separate menu button, insert a virtual bookmark at a point of interest in the document, and then later move to the point by retrieving the bookmark, or find and go to the target page by searching certain associated keywords. However, with these methods, it is not very straightforward to find and open the desired target page on a small display screen.

Accordingly, a function of enabling the user to easily find and update with the target page in a multi-page document is most pressingly needed.

### DETAILED DESCRIPTION OF THE INVENTION

### Technical Problem

The present invention provides a portable multimedia device for displaying an e-Book like a paper book, having functions of turning a page/pages of the e-Book like turning a page/pages of a paper book, to thus increase familiarity with is the e-Book.

The present invention also provides a portable multimedia device for enabling a user to use the portable multimedia device like a paper notebook by providing writing, erasing, and re-reading functions.

### Technical Solution

According to an aspect of the present invention, there is provided a portable multimedia device for displaying a document having multiple pages, including, a memory for storing the document; at least one display screen for displaying the document; and a central control unit for reading the document from the memory, and displaying the document on the at least one display screen according to an operating mode selected by a user, wherein the central control unit comprises a page indicator display module for displaying page indicators, indicating current, previous, and next pages of the document, to be selected by the user, and a target page select module for displaying on the at least one display screen a target page that corresponds to one of the page indicators selected by the user.

The page indicator display module may display the page indicators in sequence within a selection bar displayed on a certain location in the at least one display screen.

The page indicator display module may display the page indicators on the at least one display screen such that they simulate the look of pages in piles of a paper book.

The page indicator display module may further display the page indicators by adjusting them in size based on the gap in page number between the currently displayed page and pages corresponding to the page indicators.

The target page select module may display one of the page indicators selected by the user, and when the user drags or reselects the displayed page indicator, confirm that the user finally selects the displayed page indicator.

The operating mode may include at least one of a read-only, a write-only, and a combined read/write mode, and wherein the central control unit controls the at least one display screen separately in one of the operating modes.

The at least a display screen may correspond to at least a touch screen that has a contact sensor for perceiving user contact, and wherein, in one of the read-only, write-only, and the combined read/write mode, the central control unit may distinguish normal writing operations from contact mistakes, based on contact positions and areas on the at least a display screen where the user contact was made, and discards what is recognized as contact mistakes.

According to another aspect of the present invention, there is provided a method of operating a portable multimedia device for displaying a document having multiple pages, including, reading a document to be displayed from a memory; displaying the document on at least a display screen according to an operating mode selected by a user; displaying page indicators, indicating current, previous, and next pages of the document, to be selected by the user, and displaying on the at least one display screen a target page that corresponds to one of the page indicators selected by the user.

The displaying of the page indicators may include displaying the page indicators in sequence within a bar displayed on a predetermined location in each of the at least a display screen.

### Advantageous Effects

According to the present invention, users may use the e-Book device as familiar as a paper book.

Also, by attaching touch screens to dual display screens, the portable multimedia device may enable users to take a note with an electronic pen on the touch screens and store the written content as is, thus allowing users to use the portable multimedia device like a paper notebook.

### DESCRIPTION OF THE DRAWINGS

FIG. 1 is a schematic block diagram of a portable multimedia device according to an aspect of the present invention;

FIG. 2 is a perspective view of the portable multimedia device shown in FIG. 1, according to an embodiment;

FIG. 3 illustrates page indicators implemented within bars, according to a first embodiment;

FIG. 4 illustrates page indicators implemented within bars, according to a second embodiment; and

FIG. 5 is a flowchart of a method of operating a portable multimedia device, according to another aspect of the present invention.

### BEST MODE

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. However, the present invention may be implemented in many different forms, and is not limited to the exemplary embodiments. For the sake of brevity, conventional parts and functions not relevant to the scope of the present invention may not be described in detail. Like reference numerals in the drawings refer to like elements.

The term “include (or including)” or “comprise (or comprising)” is inclusive or open-ended and does not exclude additional, unrecited elements or method steps. “Unit”, “module”, “block”, etc. used herein each represent a unit for handling at least one function or operation, and may be implemented in hardware, software, or a combination thereof.

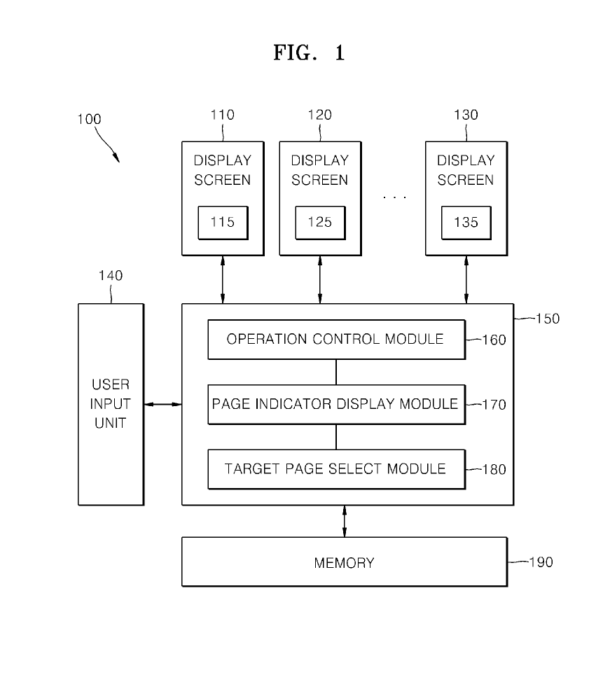

FIG. 1 is a schematic block diagram of a portable multimedia device 100 according to an aspect of the present invention.

The portable multimedia device 100 includes first through n-th display screens 110, 120, . . . , 130, a user input unit 140, a central control unit 150, and a memory 190. The central control unit 150 includes an operation control module 160, a page indicator display module 170, and a target page select module 180.

The portable multimedia device 100 employs the first through n-th display screens 110, 120, . . . , 130 to increase the amount of information to be displayed. The first through n-th display screens 110, 120, . . . , 130 may be implemented to be linked to each other and be foldable.

The first through n-th display screens 110, 120, . . . , 130 include contact sensors 115, 125, . . . , 135 for recognizing user contact, respectively. Here, it is apparent that the first through n-th display screens 110, 120, . . . , 130 may represent touch screens including the contact sensors 115, 125, . . . , 135, respectively. The central control unit 150 reads a document for display from the memory 190 and displays the document on a desired one of the first through n-th display screens 110, 120, . . . , 130. The document may also be directly received from the outside through an external interface (not shown) wirelessly. The user input unit 140 receives user inputs, e.g., of the power button, function button, etc. Although, for convenience sake, the portable multimedia device 100 is illustrated in a simple form, it may also include various additional elements, such as a camera, a speaker for an MP3 player, earphones, a microphone, an external imaging input, etc.

The entire operations of the portable multimedia device 100 are done with an operation control module 160 of the central control unit 150. Preferably, the operation control module 160 may drive the first through n-th display screens 110, 120, . . . , 130 in different modes, respectively. In other words, the operation control module 160 may separately drive each of the first through n-th display screens 110, 120, . . . , 130 in any of read-only mode (e-Book mode), write-only mode (e-Notebook mode), and combined read/write mode. As such, the user may take a note on the second display screen 120 while looking at information displayed on the first display screen 110. Alternatively, the user may take a note on the display screen 130 operating in the combined read/write mode. Operating modes will be described below in more detail.

The page indicator display module 170 displays the page indicators, indicating current, previous, and next pages, to be selected by the user. The page indicators provided for the user to select his/her desired target page may be configured as sections partitioned with line segments within a vertical or horizontal bar on each display screen, or may be implemented to be in a shape of pages in piles. The page indicators will be described below in detail with reference to associated drawings.

The target page select module 180 displays one of the page indicators selected by the user. Selection of the page indicator may be made by a user's touch or a mouse click, or by placing and maintaining a mouse pointer on the page indicator for a predetermined time (e.g., 1 second). For example, when the user selects a page indicator that corresponds to a 20th page, the target page select module 180 displays on the display screen that the 20th page has been selected. If the user finds that the 20th page is not what he/she wanted, the user may cancel the selection and touch another page indicator. Canceling the selection may be done by releasing the touch or the mouse click on the touched page indicator, or moving the mouse pointer on the page indicator onto another page indicator. On the other hand, when the user finally selects the displayed page indicator, the target page select module 180 displays the target page corresponding to the selected page indicator on the touch screen. At this time, the target page select module 180 may simulate book pages being turned over from the current page to the target page, as in real life. In a case that the first through n-th display screens 110, 120, . . . , 130 have no contact sensors, respectively, the target page select module 180 displays on one of the first through n-th display screens 110, 120, . . . , 130 a target page corresponding to a page indicator selected by moving the mouse pointer onto the page indicator and then clicking the mouse. As such, the first through n-th display screens 110, 120, . . . , 130 are not necessarily touch screens, and the present invention applies equally to conventional display screens having no touch function.

### MODE OF THE INVENTION

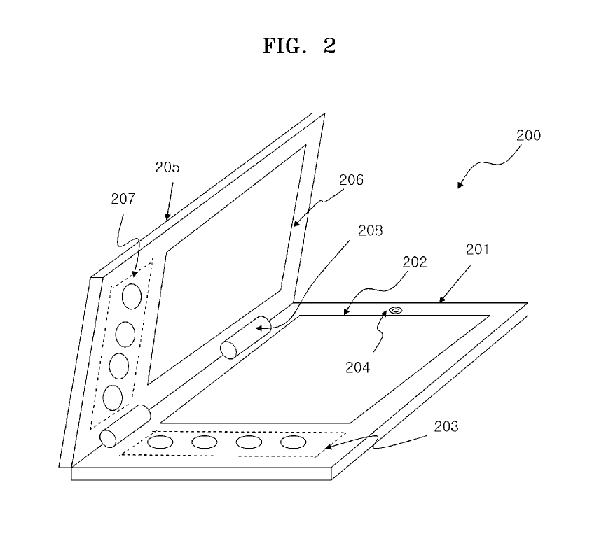

FIG. 2 is a perspective view of the portable multimedia device 100 shown in FIG. 1, according to an embodiment.

A portable multimedia device 200 includes a first main body 201 that has a touch screen 202, a first user input unit 203, and a digital camera 204, and a second main body 205 that has a flat panel touch screen 206 and a second user input unit 207. The first and second main bodies 201 and 205 are coupled with each other via connections 208 and operate as dual displays in the portable multimedia device 200.

The first and second user input units 203 and 207 may include user interface manipulation devices including buttons or touch pads for turning on or off the portable multimedia device 200 as well as for selecting, storing, reproducing, or processing information on the touch screens 202 and 206. The touch screens 202 and 206 have touch screen functions for users to input messages with electronic pens, real pencils, or equal writing stationary.

The portable multimedia device 200 may have one or more operation service modes, such as an e-Book/e-Notebook mode, a PMP mode, a combined PMP/e-Book/e-Notebook mode, a Mobile Internet Device (MID) mode, or a combined MID/e-Book/e-Notebook mode. When the user selects one of the service modes through directional keys and an enter key provided in the first user input unit 203, driver software drives corresponding software for the selected service mode to operate the portable multimedia device 200 in the service mode.

The service modes are:

1) The e-Book/e-Notebook mode: lists of e-Books and e-Notebooks, and service menus are provided on a menu screen, the service menu having sub-menus, such as open book, open notebook, take a note, etc. The sub-menu of opening book further provides a two-page open option for using both of the touch screens 202 and 206, and a one-page open option for using only one of the touch screens 202 and 206.

The two-page open option displays two pages of an e-Book or an e-Notebook on the left and right touch screens 206 and 202, respectively, like an unfolded paper book or an unfolded paper notebook. On the other hand, the one-page open option displays only one page of the e-Book or the e-Notebook on one of the touch screens 202 and 206.

For the e-Notebook, a copyright owner of the e-Notebook, who is also a user of the e-Notebook device according to the present invention, may apply copyright options when he/she makes contents of the e-Notebook. One of the copyright options may be an option of whether or not to allow someone else's e-Notebook device to open the content of the e-Notebook. In other words, as free transfer of an e-Book is commonly limited between a user who purchased the e-Book and other users of other e-Book devices, distribution rights and licensing for the e-Notebook are also given to the copyright owner.

In the e-Notebook mode, the user may store content written by the user, in addition to e-Book content. For example, if the user took notes while reading an e-Book, the user may store the notes (also called ‘user contents’) separately from the e-Book content without changing the e-Book content. Thus, the user may always return to the original e-Book content, excluding a note the user wrote. The user content may be compressed with the Modified Huffman (MH) encoding scheme, or a combination of the MH encoding scheme and Modified Read (MR) and Modified Modified Read (MMR) encoding schemes.

2) PMP and a combined PMP/e-Book/e-Notebook modes: the left and right touch screens 206 and 202 are separately controlled in the PMP mode, i.e., each of the touch screens 202 and 206 is provided with video multimedia content list and content selected from the content list is reproduced only in the touch screen where the content list is displayed. Therefore, in the case that the content is videos, different videos may be displayed on the two screens, respectively.

In the combined PMP/e-Book/e-Notebook mode, one of the touch screens (202 and 206) may serve as a screen for PMP while the other touch screen may serve as a screen for the e-Book/e-Notebook.

3) MID and combined MID/e-Book/e-Notebook modes: in the MID mode, the Internet may be used on the two touch screens. At this time, a two-page Web open option for displaying a single Web content continuously on both the left and right touch screens 202 and 207 and a one-page Web open option for displaying different Web content on the touch screens 202 and 206, respectively, are provided. In the two-page Web open option, since the left and right touch screens 202 and 206 display a Web page, scrolling the page down may shift content from the left touch screen 206 to the right touch screen 202. In the combined MID/e-Book/e-Notebook mode, the right touch screen 202 may serve as a screen for the e-Book/e-Notebook while the left touch screen 206 serves as a screen for Internet, and in this case, the one-page Web open option and the one-page open option are forced to be employed for displaying the Web and e-Book/e-Notebook, is respectively.

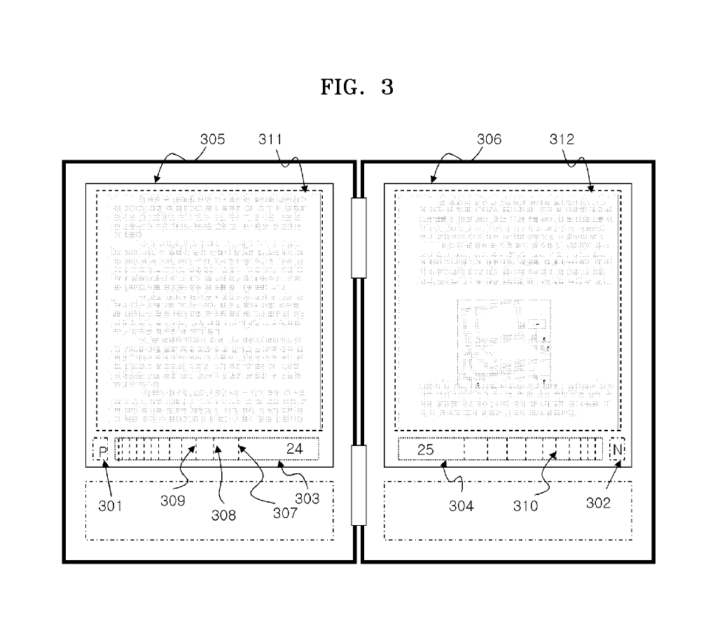

FIG. 3 illustrates page indicators implemented within bars, according to a first embodiment.

The present invention is characterized in that the dual display multimedia device displays content on dual display screens by simulating a paper book unfolded into two pages, and thus, provides the same effect as looking at a paper book to thus give the user a feeling of reading a paper book.

First, by displaying two pages of content on the two touch screens, namely, first and second touch screens 305 and 306, respectively, it makes the user familiar with the e-Book as if the user is reading a paper book. On the first and second touch screens 305 and 306, a first touch bar 301 for turning a page forward, a second touch bar 302 for turning a page backward, a first touch toolbar 303 for displaying page indicators corresponding to a currently displayed page (current page) on the left and previous pages from the current page, and a second touch toolbar 304 for displaying a current page on the right and next pages to the current page are displayed. When the user presses or contacts unfolded e-Book screens 311 and 312, or the first and second touch toolbars 303 and 304, or when the user contacts and drags them in the up, down, left, or right direction, such contact locations and directions are recognized.

The method of turning pages of the e-Book in the e-Book device having the functions described above is implemented as follows. In this example, the e-Book device displays the 24th and 25th pages on the unfolded e-Book screens 311 and 312, and if the user wants to turn the pages to the 26th and 27th pages, then he/she touches the second touch bar 302 or drags the e-Book screen 312 in the second touch screen 306 to the left. On the contrary, to display the 23rd or 22nd page, the user touches the first touch bar 301 or drags the e-Book screen 311 in the first touch screen 305 to the right.

The first and second touch toolbars 303 and 304 are partitioned with dashed lines 307, 308, 309, and 310 into sections, each section being a page indicator that represents a corresponding page. The page indicators, which are displayed like edges of a paper book when the paper book is unfolded, visually represent physical locations corresponding to partition of pages of the e-Book. Herein, the page indicators are displayed as sections partitioned from each other with borders of dashed lines or solid lines, but even if the borders are selected, it is considered that either of adjacent sections, i.e., page indicators, is selected, for convenience sake. The total number of page indicators corresponds to the number of pages of the unfolded e-Book on the e-Book screens 311 and 312. When a page is turned forward/backward, the number of page indicators displayed on both of the first and second touch screens 305 and 306 is changed. The page indicators nearer to the both ends of the first and second touch toolbars may be implemented smaller in size, as would be page edges of an unfolded paper book. Alternatively, as in this embodiment, the page indicator indicating the current page may be implemented to look biggest while the page indicators indicating far pages from the current page may be implemented smaller. The reason is that turning pages nearer to the current page should be elaborately performed.

Since the page indicators 307, 308, 309, and 310 are implemented to correspond to pages of the e-Book, when the user touches a vertical dashed line in a specific location and drags in the left or right direction, several pages are turned over at a time from the page corresponding to the vertical dashed line in the left or right direction.

Specifically, for example, when the user touches the vertical dashed line 309 in the first touch toolbar 303 and drags in the right direction, three pages corresponding to the page indicators 309, 308, and 307 are turned to the right at a time, thus resulting in the 18th and 19th pages displayed on the e-Book screens 311 and 312 of the first and second touch screens 305 and 306, respectively. At this time, a number ‘18’ is displayed in the first touch toolbar 303 while a number ‘19’ is displayed in the second touch toolbar 304, and the number of vertical dashed lines in the first touch toolbar 303 decreases by 3 while the number of vertical dashed lines in the second touch toolbar 304 increases by 3. As an another example, if the user touches the page indicator 310 in the second touch toolbar 304 and drags in the left direction, all pages on the left from the page 310 are turned over in the left direction, resulting in the 36th and 37th pages displayed on the e-Book screens 311 and 312 of the first and second touch screens 305 and 306, respectively. At this time, a number ‘36’ is displayed in the first touch toolbar 303 while a number ‘37’ is displayed in the second touch toolbar 304, and the number of vertical dashed lines in the first touch toolbar 303 increases by 6 while the number of vertical dashed lines in the second touch toolbar 304 decreases by 6.

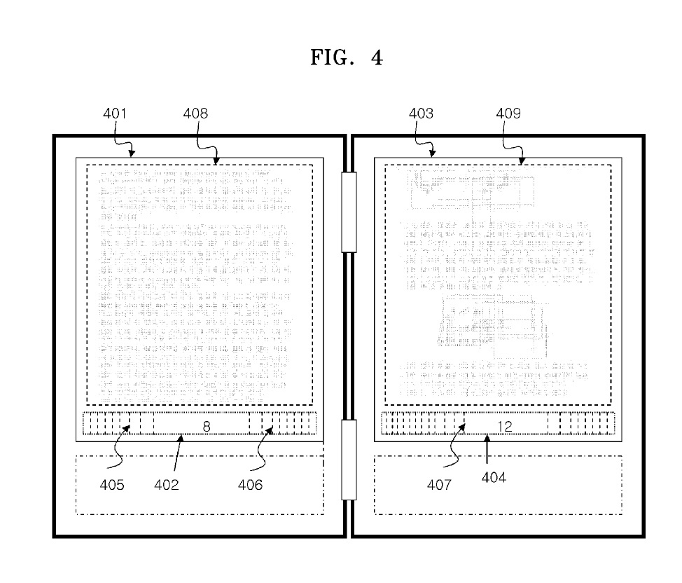

FIG. 4 illustrates page indicators implemented within bars, according to a second embodiment.

In FIG. 4, each of first and second toolbars 402 and 404 includes a section for representing a current page number of an e-Book displayed on each of first and second e-Book screens 408 and 409 of first and second touch screens 401 and 403. The first and second touch toolbars 402 and 404 also each include vertical dashed lines for visualizing the amount of pages ahead of and behind the current page. That is, a page number of the current page on the e-Book screen 408 is displayed in the center of the first touch toolbar 402, and a number of vertical dashed lines corresponding to a number of pages ahead of and behind the current page are displayed on the left and right of the page indicator for the current page, thus giving the user a visual effect as if the user opens and reads an unfolded paper book.

Turning a page forward or backward is done by touching any location in the e-Book screens 408 and 409 of the touch screens 401 and 403 and dragging in the left or right direction. As such, the same look as pages of a paper book being turned over in the left or right direction is implemented. Since the current page displayed on the first e-Book screen 408 is the 8th page, in this example, as shown in FIG. 4, when the user touches the first e-Book screen 408 and drags in the left direction, the first e-Book screen 408 is updated with the next page, i.e., the 9^{th} page, the page number represented in the center of the first touch toolbar 402 is also updated with ‘9’, and vertical dashed lines increases by 1 in the left direction while decreasing by 1 in the right direction. Since the mechanism of turning several pages at a time in this embodiment of FIG. 4 is similar to that of FIG. 3, a repeated description thereof is omitted. Alternatively, the widest section for representing the current page may be shifted according to the position of the current page among the entire pages of the e-Book. For example, for an e-Book having 50 pages in total, if the user has the 1^{st} page displayed on the first e-Book screen 408, then the page indicator for the current page is placed leftmost in the first touch toolbar 402, the position of the page indicator for the current page being shifted gradually to the right direction as the current page number increases, and if the current page is 50, the page indicator for the current page may be placed rightmost in the first touch toolbar 402.

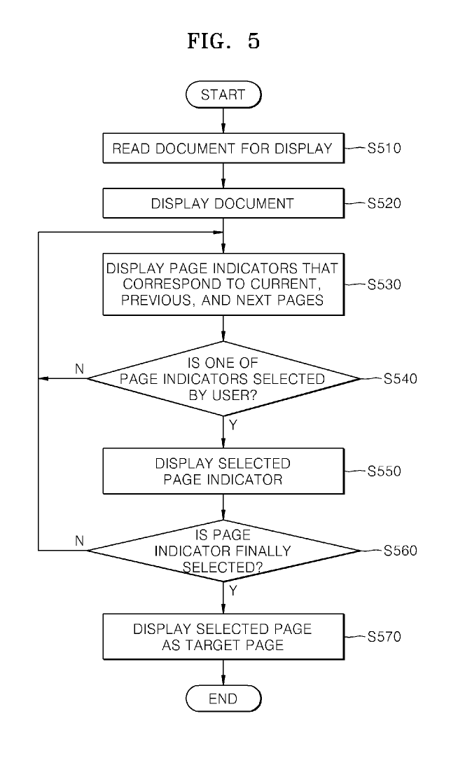

FIG. 5 is a flowchart of a method of operating a portable multimedia device, according to another aspect of the present invention.

The method begins with reading a document to be displayed from the memory and displaying the document on touch screen(s) according to an operating mode selected by the user, in operations S510 and S520. The operating mode selected by the user may be one of the read-only mode, write-only mode, and a combined read/write mode, as described above.

Then, in operations S530, the page indicators, indicating current, previous, and next pages of the document, are displayed to be touched by the user. The page indicators, indicating respective pages of the document, are partitioned with vertical or horizontal split-lines within a bar, or are in the form of edges of a paper book that has pages in piles.

When the user selects one of the displayed page indicators in operation S540, the page indicator selected by the user from among the other page indicators is displayed in operation S550. Then, it is determined whether the user finally selects the page that corresponds to the selected page indicator as a target page, in operation S560.

As described above, the user may finally select the displayed page as the target page by touching and holding the displayed page for a predetermined second, touching the displayed page and dragging in the desired direction, or re-selecting the page indicator for the displayed page. As such, once the user finally selects the target page, the target page is displayed on the touch screen, in operation S570. When the portable multimedia device operates in the e-Notebook mode, content written by the user may be stored based on a store instruction or automatically when/after the page is turned over. In a case of storing the content written by the user in a non-volatile memory, an image of the e-Notebook screen may be stored as is. In this regard, as a way of compressing the content or the image of the e-Notebook page, MH, MR, or MMR encoding specified in ITU-T standard T.4 and T.6 for image compression and coding of a screen to be transmitted from a is commercial G3 fax machine may be used.

To prevent a pen writing operation or contacting the touch screen with a human finger or a palm from being mistakenly recognized as normal touching or dragging operations, touch toolbars for allowing the user to turn several pages and to turn a page may be placed on an upper area of the touch screens such that wrong contacts may not cause page turning.

With a writing mode or an eraser mode, a function of canceling a noise due to all touches other than those with writing stationery and erasers, such as, touches with human fingers or palms, is required. For this, a mechanism for utilizing user contact positions and areas on the touch screens to distinguish normal writing operations from contact mistakes may be implemented. In this regard, normal writing may be performed in the left to right direction with respect to a position where a current writing position is, and it may also proceed from the rightmost position of a line to the leftmost position in the next line. Therefore, if there is any contact out of such a writing rule, it may be considered noise. Alternatively, there may be a mechanism for determining the contact mistake when a smaller area of contact is recognized compared with a predetermined area of contact.

While the present invention has been particularly shown and described with reference to exemplary embodiments thereof, it will be understood by one of ordinary skill in the art that various changes in form and details may be made therein without departing from the scope of the present invention. For example, the portable multimedia device according to the present invention may be implemented as a dual folder device having an additional phone functioning unit in the back of a side of the device, thus operating as a cellular phone when it is in a folded state or as a pocket-type e-Book or e-Notebook device, or a PMP device when it is unfolded, or may be implemented to be in a type of smart phone having three display screens for an MID device. Such a smart phone may allow using the Internet, receiving emails, purchasing and downloading e-Books, and providing pocketbook type e-Book and e-Notebook services online through an RF communications capability provided by its modem.

It should be understood that spirit and scope of the present invention are only defined by the following claims.

### INDUSTRIAL APPLICABILITY

According to the present invention, by utilizing multiple display screens, even a PMP device or an MID device may allow the user to enjoy multimedia services on a display screen while taking a note or writing on the other display screen (e.g., studying while enjoying music or movies at the same time), thus making it possible to develop more enriched services.

1. A portable multimedia device for displaying a document having multiple pages, comprising,
a memory for storing the document;
at least one display screen for displaying the document; and
a central control unit for reading the document from the memory, and displaying the document on the at least one display screen according to an operating mode selected by a user,
wherein the central control unit comprises a page indicator display module for displaying page indicators, indicating current, previous, and next pages of the document, to be selected by the user, and a target page select module for displaying on the at least one display screen a target page that corresponds to one of the page indicators selected by the user.

2. The portable multimedia device of claim 1, wherein the page indicator display module displays the page indicators in sequence within a selection bar displayed on a certain location in the at least one display screen.

3. The portable multimedia device of claim 1, wherein the page indicator display module displays the page indicators on the at least one display screen such that they simulate the look of pages in piles of a paper book.

4. The portable multimedia device of claim 2, wherein the page indicator display module further displays the page indicators by adjusting them in size based on the gap in page number between the currently displayed page and pages corresponding to the page indicators.

5. The portable multimedia device of claim 1, wherein the target page select module displays one of the page indicators selected by the user, and when the user drags or reselects the displayed page indicator, confirms that the user finally selects the displayed page indicator.

6. The portable multimedia device of claim 1, wherein the operating mode may include at least one of a read-only, a write-only, and a combined read/write mode, and
wherein the central control unit controls the at least one display screen separately in one of the operating modes.

7. The portable multimedia device of claim 6, wherein the at least a display screen corresponds to at least a touch screen that has a contact sensor for perceiving user contact,
and wherein, in one of the read-only, write-only, and the combined read/write mode, the central control unit distinguishes normal writing operations from contact mistakes, based on contact positions and areas on the at least a display screen where the user contact was made, and discards what is recognized as contact mistakes.

8. A method of operating a portable multimedia device for displaying a document having multiple pages, comprising,
reading a document to be displayed from a memory;
displaying the document on at least a display screen according to an operating mode selected by a user;
displaying page indicators, indicating current, previous, and next pages of the document, to be selected by the user, and
displaying on the at least one display screen a target page that corresponds to one of the page indicators selected by the user.

9. The method of claim 8, wherein displaying the page indicators comprises displaying the page indicators in sequence within a bar displayed on a predetermined location in each of the at least a display screen.

10. The portable multimedia device of claim 3, wherein the page indicator display module further displays the page indicators by adjusting them in size based on the gap in page number between the currently displayed page and pages corresponding to the page indicators.
